(19) United States
(12) Patent Application Publication
(10) Pub. No.: US 2004/0244914 A1
(43) Pub. Date: Dec. 9, 2004

(54) Collapsible shaping drum

(75) Inventor: Mark S. Byerley, Greenback, TN (US)

Correspondence Address: PITTS AND BRITTIAN P C, P O BOX 51295, KNOXVILLE, TN, 37950-1295, US

(73) Assignee: Wyko, Inc., Greenback, TN

(21) Appl. No.: 10/457,768

(22) Filed: Jun. 9, 2003

(51) Int. Cl. B29D 30/24

(52) U.S. Cl. 156/417; 156/414

(57) ABSTRACT

A flange for a tire building drum having a transverse central plane and including a central shaft having a longitudinal axis which defines a rotational axis of the drum including first and second sets of outer-circumference defining shoes which are expandable from radially retracted positions internally of the drum to radially extended positions to define first and second mirror image circumferential radial flanges which are disposed on respective ones of the opposite sides of, and parallel to, the transverse central plane of the drum, each set of shoes including a plurality of individual shoes, each of which is a generally triangular geometry when viewed in a plan view thereof and having respective apices, bases and opposite sides.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

In the prior art, vehicle tires are manufactured employing various methods. One common method involves the steps of; (a) forming a cylindrical carcass of a rotating cylindrical drum, (b) removing the carcass and loading it onto a shaping drum where the toroidal shape of the tire is established, and including the initial incorporation of a belt and tread package onto the toroidal shape; (c) introduction of the shaped carcass with its belt and tread package into a mold wherein the components of the tire are molded together into the desired final geometry of the tire.

Several of the prior art drums include radial flanges which are adapted to be radially extended to provide forming surfaces for one or more components of a tire, and radially collapsible to permit the withdrawal of a cylindrical or toroidal tire or tire component from the drum. Commonly, it is required that there be multiple drums for the manufacture of a given tire with resulting need to transfer the partially formed tire between drums.

The radial flanges of prior art tire building drums have multiple shortcomings, including the complexity of the mechanism required to accommodate the collective transition of multiple circumference-defining components from radially inward positions to radially outward positions, the inability to define a fully closed circumferential outer surface onto which tire components can be formed, and their cost of manufacture and maintenance, among others. Moreover, structural stability of the multiple components of certain of the prior art flanges precludes their use in those instances where substantial deformation forces are imposed upon the flanges by the tire formation process.

Also of importance is the inability of certain flanges of the prior art to provide uniform circumferential support for the raw components of the tire as they are applied onto the drum and/or a partially formed tire on the drum. This lack of uniform circumferential support can result in the finished tire being “out of round” and unusable on a vehicle.

### BRIEF SUMMARY OF THE INVENTION

In accordance with one aspect of the present invention, the present inventor provides a novel, radically adjustable, flange for a tire building drum having a central longitudinal shaft (which further defines a rotational axis of the drum) and a shoe-supporting sleeve associated with the shaft. In the present invention there are provided first and second sets of outer-circumference defining shoes which are moveable, preferably simultaneously, between radially retracted positions substantially internally of the drum and radially extended positions, to define first and second mirror image circumferential radial flanges which are disposed on respective ones of the opposite sides of a transverse centerplane of the drum.

Each flange of the present invention comprises a plurality of individual shoes, each of which is of a generally planer triangular geometry when viewed in a plan view thereof. In one embodiment, the shoes of a given flange are disposed in units of three shoes. One of the shoes of a given unit is denominated the central first shoe and is central to the second and third shoes of the unit. The second and third shoes of this unit are disposed in flanking relationship to respective ones of the opposite sides of the first shoe. The apex of the central first shoe is disposed radially outward of the drum shaft and the apices of the second and third shoes are disposed radially inwardly of the drum shaft.

Each shoe is provided with alternating projections and indentations along each of its opposite side margins. The projections and indentations along one side of the central first shoe mesh with the indentations and projections along a first side of the second shoe. The projections and indentations along the opposite and second side of the first central shoe mesh with the indentations and projections along a first side of the third shoe, thereby completing a three-shoe unit.

In the three-shoe unit, the projections and indentations along the second side of the second shoe (opposite the central first shoe) are exposed to mesh with the indentations and projections of a further third shoe of a further three-shoe unit. In similar manner, the projections and indentations along a second side of the third shoe are exposed to mesh with the indentations and projections along a side margin of a further second shoe of a further three-shoe unit.

The meshing projections and indentations of adjacent margins of adjacent shoes of each unit of shoes are hingedly joined by appropriate pin means such that each of the three shoes of a unit of shoes are hinged to move relative to one another and multiple units of three shoes are hinged together to collectively define a circumferential flange.

As noted, among the shoes of a given flange, each generally triangular shoe is hinged along two of its opposite sides to neighboring shoes. Further, at least one of the shoes of each unit of three shoes is hinged to a flanged sleeve which is axially slidably mounted on the central shaft for positioning of the sleeve and its units of shoes axially relative to the transverse centerplane of the drum. An actuator is associated with the sleeve and, in a preferred embodiment, is operatively connected to the central first shoe of each unit of shoes as by one or more links, whereby activation of the actuator effects radial positioning of the shoes of each set of shoes of each flange radially inwardly or outwardly with respect to the rotational axis of the drum, and the axially movement of the sleeve serves to axially position the two flanges of the drum relative to the transverse centerplane of the drum. The hinged movement of the shoes relative to one another, the hinged movement between adjacent units of shoes, and the hinged movement of each unit of shoes about their hinged connection to the support sleeve, effects substantially simultaneous radial movement of all of the shoes of each flange relative to the longitudinal axis of the drum.

A flange of the present invention may be employed on any of a myriad of types of vehicle tire making drums which are known in the art.

### BRIEF DESCRIPTION OF THE SEVERAL VIEWS OF THE DRAWINGS

FIG. 1 is a representation of a drum, part in section, embodying various of the features of the present invention;

FIG. 2 is a side elevational view, of a section, of the right-hand subassembly depicted in FIG. 1, and depicting the shoes of this flange generically;

FIG. 3 is a representation, generally in end elevation view, of the left hand end of the drum depicted in FIG. 1;

FIG. 4 is a representation, generally in plan view, of one embodiment of a unit of three shoes of a flange of the present invention;

FIG. 5 is a side elevation view of the unit of shoes depicted in FIG. 4;

FIG. 6 is a representation of a second shoe of the unit of shoes depicted in FIG. 4:

FIG. 7 is a side elevation view of the second shoe depicted in FIG. 4;

FIG. 8 is a representation of a central first shoe of the unit of shoes of FIG. 4 and depicting the radially inward surface of the shoe;

FIG. 9 is a side elevation view of the central first shoe of the unit of shoes depicted in FIG. 4;

FIG. 10 is a plan view of the third shoe of the unit of shoes depicted in FIG. 4;

FIG. 11 is a side elevation view of the third shoe depicted in FIG. 10;

FIG. 12 is a representation, in plan view, of a further embodiment of a unit of shoes as employed in the present invention;

FIG. 13 is a schematic representation of one embodiment of a radially expanded flange embodying various of the features of the present invention; and,

FIG. 14 is a schematic representation of one embodiment of a partially radially extended flange embodying various of the features of the present invention.

### DETAILED DESCRIPTION OF THE INVENTION

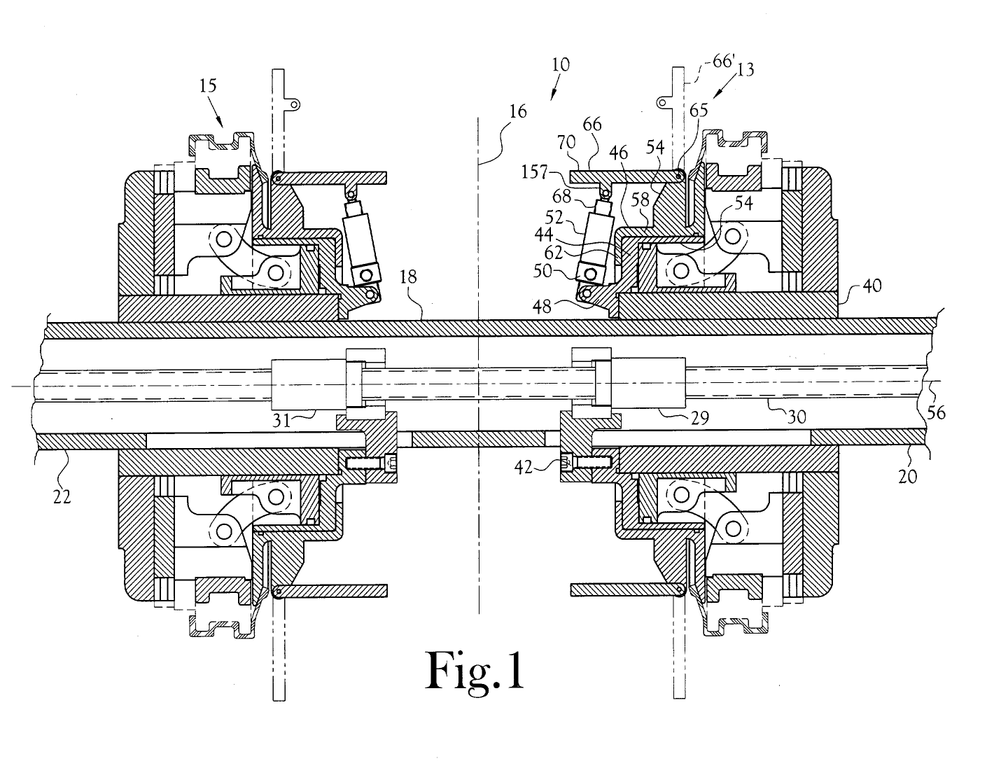

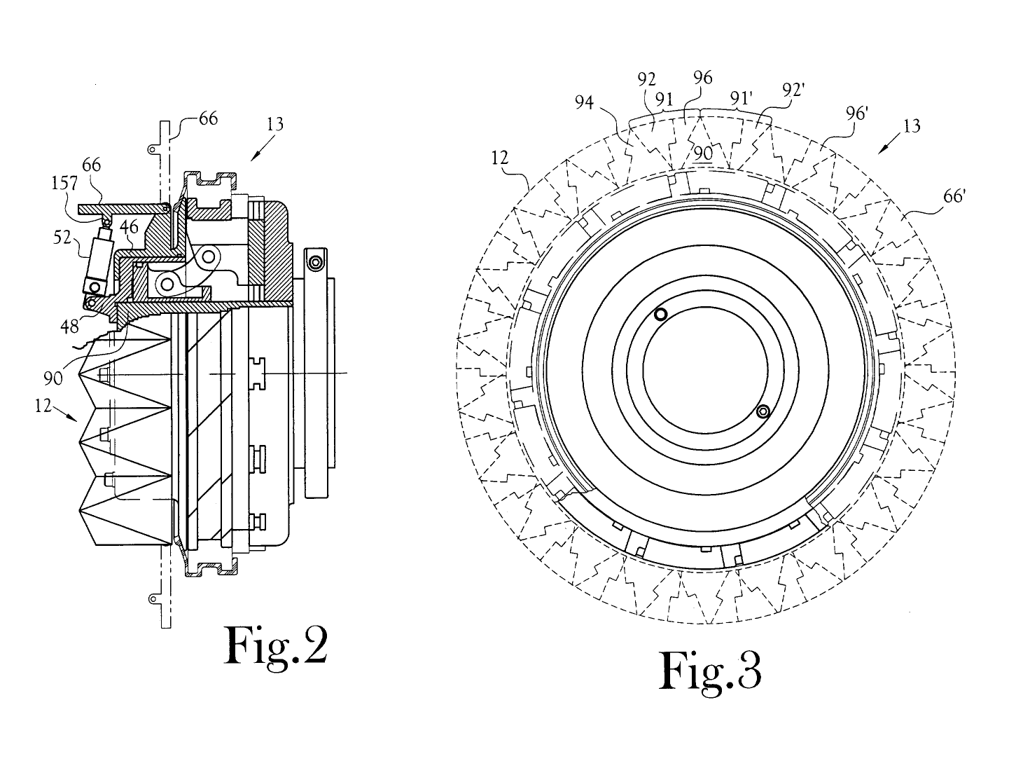

Referring initially to FIGS. 1 and 2, there is depicted one embodiment of a tire-building drum 10 which includes first and second subassemblies 13 and 15 which are axially reciprocatably mounted on opposite sides of the transverse centerplane 16 of a hollow tubular central shaft 18. A first end 20 of the drum is provided with a first conventional end plate (not shown) adapted to provide means for mounting the shaft on a conventional tire-making machine (not shown), for example. The opposite and second end 22 of the shaft includes a second conventional end plate (not shown). Internally of the central shaft 18 and extending between the first and second ends of the drum, there is provided a conventional double-directionally externally threaded lead screw 30 which is connected in axial driving relationship to the first and second subassemblies by lead nuts 29 and 31 which are well known in the art. Access to the screw for rotation thereof is provided via a port provided in the second end plate in a manner known in the art.

As depicted in FIGS. 1 and 2, in accordance with one embodiment of the present invention, each of the subassemblies 13 and 15 includes a first cylindrical sleeve 40, mounted in axially slidable relationship on the outer circumference of the central shaft 18.

It will be recognized that axial movement of the sleeve 40 (and simultaneous axial movement of the flange ring 46) is effected by an interconnection of each of these sleeves to the double-directional threaded lead screw 30 so that rotation of the screw simultaneously moves the sleeves either toward or away from the transverse centerplane 16 of the drum as is well known in the art.

Further, it will be recognized by one skilled in the art that means other than piston-cylinders 52 may be employed to adjust the radial positions of the shoes 66, such as for example, a ring-shaped actuator. This actuator may be axially positionable relative to the sleeve 40, by any of several means well known in the art, such as employing pneumatic or hydraulic pressure or by mechanical means (not shown). In an alternative embodiment, there may be provided linkage from the shoes to the actuator. It will be recognized, in any event, that movement of the actuator will function to simultaneously rotate the several shoes of the circumferential flange radially inwardly or outwardly of the drum relative to the longitudinal axis of the drum, depending upon the direction of movement of the actuator.

Referring to the subassembly depicted in FIG. 1, this first sleeve 40 is secured as by bolts 42, to a connector 42 which connects a lead nut 29 with a connector ring 44, which in turn, serves to mount thereon a flange ring 46.

In the depicted embodiment, the connector ring 44 includes a plurality of lugs 48 which project from the connector ring generally axially inwardly from the connector ring toward the transverse centerplane 16. Each of these lugs serves to mount thereon a first end 50 of a piston-cylinder actuator 52, for example.

Again in the depicted embodiment, the connector ring further includes a circumferential flange portion 54 which is aligned parallel to the rotational axis 56 of the drum which serves to receive thereon the body portion 58 of a multi-flanged flange ring 46 whereby rotation of the shaft 18 serves to likewise rotate the flange ring about the rotational axis of the shaft 18.

As depicted in FIG. 1, the flange ring 46 includes a first radial flange 62 which projects radially inwardly of the drum and overlies and engages the body portion of the connector ring 44, and a second radial flange 64 which projects radially outwardly from the body portion 58 of the flange ring to hingedly receive in spaced apart locations 65 about its outer circumference, a plurality of flange shoes 66.

Each flange shoe 66 is hingedly connected to a second end 68 of a piston-cylinder actuator 52 whereby actuation of the piston-cylinder actuator 52 serves to move the outboard end 70 of a respective shoe 66 (or unit of shoes) angularly about the its hinged mounting location 65 to the outer circumference of the second radial flange of the flange ring. In FIG. 1, the shoe 66 is depicted as having a first position in which the length dimension of the shoe is oriented substantially parallel to the rotational axis of the drum and a second position, depicted in phantom, in which the length dimension 66′ of the shoe is oriented substantially perpendicular to the rotational axis of the drum.

In FIG. 3 there is depicted an end view of the subassembly 13 and depicting the shoes 66′ rotated to respective positions that are perpendicular to the rational axis 56 of the shaft 30. Through selection of the linkage between the shoes and their actuator, the shoes may be rotated past their perpendicular positions, if desired.

The structure of the second subassembly 15 of the depicted drum is substantially a mirror image of the first subassembly 13. Inasmuch as the first and second subassemblies are interconnected to the screw 30, the sleeves of the first and second subassemblies move simultaneously either toward or away from one another upon rotation of the screw. Moreover, through employment of a common source of power for effecting the movement of the actuators for the shoes, these components may simultaneously rotate the shoes of the first and second circumferential flanges radially inwardly or outwardly of the drum, such radial movement of the shoes of the flanges being independent of the axial movement or position of the first and second subassemblies.

Referring to FIGS. 3 and 4 specifically, in one embodiment of an adjustable circumferential flange 12 of the present invention, there are depicted multiple units 91 of three shoes 92, 94 and 96, each. The shoes are depicted in their radially outward relationship to partially define an outer circumferential surface 90 (facing outwardly of the plane of FIG. 3) of a circumferential flange 12. A unit 91 of shoes is further depicted in FIG. 4. Each of the shoes of this unit is of a generally triangular geometry when viewed in a plan view thereof and are grouped in units of three shoes per unit. The depicted unit 91 comprises a first central shoe 92 (see also FIG. 4) a flanking second shoe 94 and a third shoe 96.

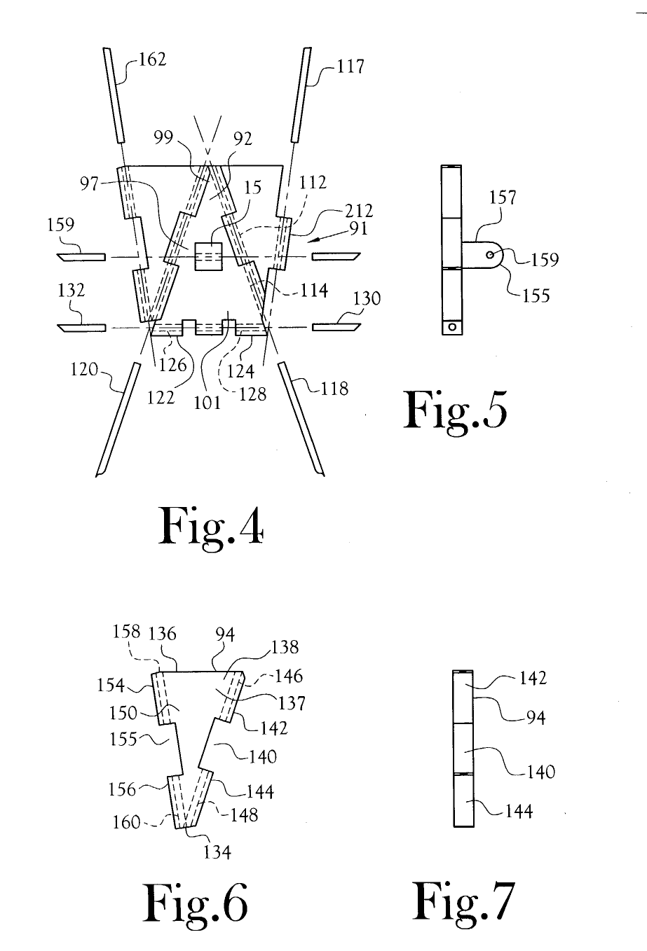

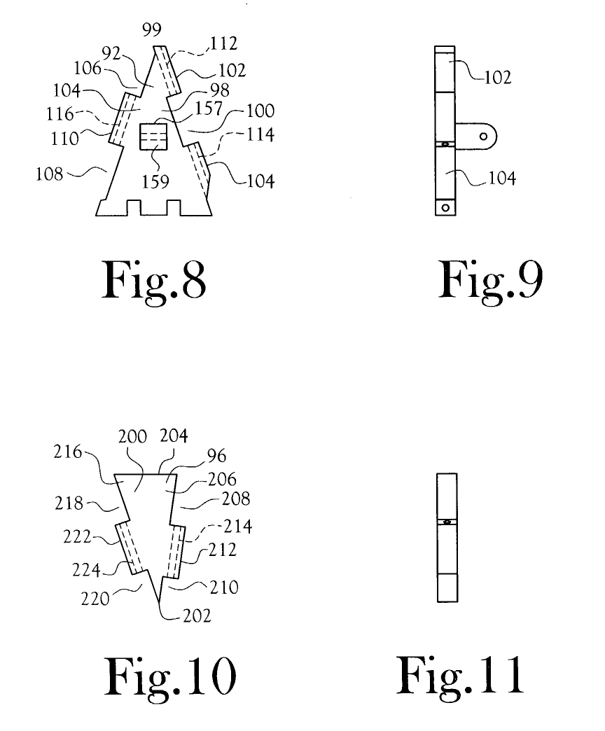

The first central shoe 92 is of substantially isosceles triangular geometry and includes a body portion 97 defining an apex 99 and a base 101. Referring to FIGS. 4-9, the first side margin 98 of the first shoe is provided with a plurality of alternating indentations 100 and projections 101, 104. The second side margin 104 of the first shoe is also provided with a plurality of alternating indentations 106, 108, and a projection 110. Each projection is provided with a throughbore which extends through the thickness of the projection, for example throughbores 112 and 114 which extend through the projections 102 and 104 and a throughbore 116 which extends through the projection 110. On each respective side of the shoe, the throughbores of the several projections thereon are in straight line axial registration with one another for the receipt therethrough of a hinge pin 118, 120, respectively. The base 101 of the central shoe is provided with first and second lugs 122, 124 projecting outwardly therefrom. Each lug is provided with a throughbore 126, 128, respectively, through its width and adapted to receive a respective hinge pin 130, 132 therein to hingedly mount this first shoe to the radial flange 64 of the flange ring 46 (FIG. 1).

As depicted in FIGS. 4, 6 and 7, a second shoe 94 of a unit of three shoes is also of substantially isosceles triangular geometry and includes a body portion 135 which defines an apex 132 and a base 136. The orientation of the second shoe in FIG. 6 is like the orientation of the same shoe in the unit of shoes depicted in FIG. 4. The first side margin 138 of the second shoe 94 is provided with projections 142, 144 separated by an indentation 140. Each of the projections 142,144 is provided with a throughbore 146, 148, respectively, through the length thereof, with the bores 146, 148 being in straight line axial registration for the receipt of the hinge pin 120 therethrough. The opposite side margin 150 of the second shoe is also provided with projections 154, 156 which are separated by an indentation 155. Each of the projections 154, 156 is provided with a throughbore 158, 160, respectively, through the length thereof, with these bores being in straight line axial registration to receive the hinge pin 162 therethrough. (See FIG. 4)

When assembled with a first shoe 92 of a first unit of shoes, the projections 142, and 144 along the side margin 138 of the second shoe mesh into the indentations 106, 108, respectively, disposed on the side margin 104 of the first shoe 92, with the throughbores 158, 160 of the projections of the second shoe in straight line axial registration with the throughbore 116 of the projection 110 of the first shoe. As depicted in FIG. 4, a hinge pin 120 is inserted into the registered throughbores to effect the desired hinged relationship between the first and second shoes. Importantly, it is to be noted that the apex 134 of the second shoe is disposed radially inwardly of the drum in contradistinction to the orientation of the apex 99 of the first shoe 92. When so assembled with the first shoe, the alternating indentation 155 and projections 154, 156 disposed along the second side margin 150 of the second shoe 94 are exposed for receiving complementary projections and indentations of a further shoe of a further unit of shoes, specifically, a third shoe of such further unit of shoes.

In the embodiment of the first shoe 92 of each unit of shoes, the first shoe is provided with a link 157 by means of which the central first shoe 92 is connected to its actuator 52.

With reference to FIG. 4, in particular, a third shoe 96 of a unit of shoes includes a body portion 200 which defines an apex 202 and a base 204. The orientation of the second shoe in FIG. 10 is like the orientation of the same shoe in the unit of shoes of FIG. 4. The first side margin 206 of the third shoe 96 is provided with a plurality of alternating indentations 208 and 210 and a central projection 212. The projection 212 is provided with a throughbore 214 through the thickness thereof for the receipt of a hinge pin 117 therethrough. The opposite side margin 216 of the second shoe is also provided with a plurality of alternating indentations 218, and 220 and a projection 222 therebetween. The projection 222 is provided with a throughbore 224 through the thickness thereof for the receipt of the hinge pin 118 therethrough.

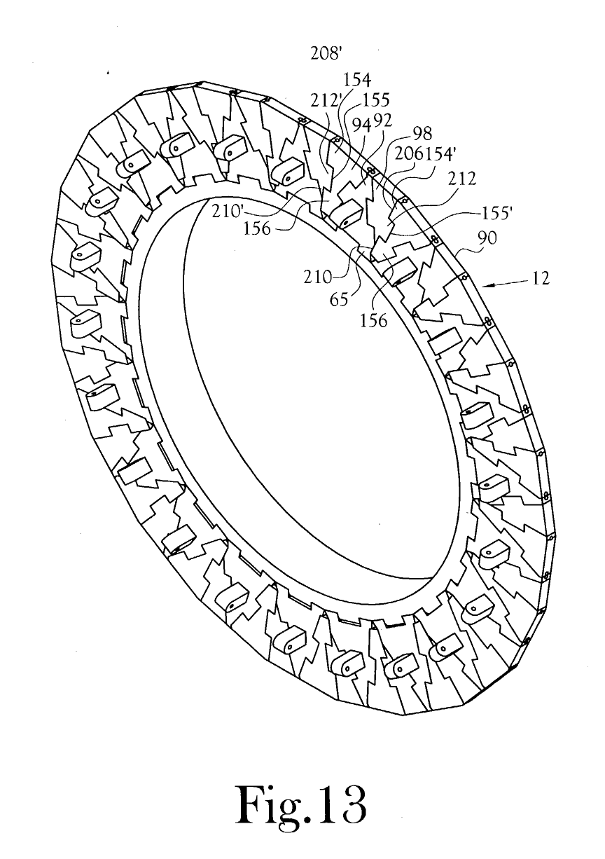

Referring to FIGS. 4 and 13, when assembled into a unit of shoes, the projection 222 along the side margin 216 of the third shoe 96 meshes into the indentation 100, dispod on the side margin 98 of the first shoe, with the throughbore 224 of the projection of the third shoe 96 in register with the throughbores 112, 114 of the projections 102 and 104 of the first shoe. As depicted in FIG. 4, a hinge pin 118 is inserted into the registered throughbores to effect the desired hinged relationship between the first and third shoes. Importantly, it is to be noted that the apex 202 of the third shoe is disposed radially inwardly of the drum in contradistinction to the orientation of the apex 99 of the first shoe 92. When so assembled with the first shoe, the alternating indentations 208, 210 and projection 212 disposed along the first side margin 206 of the third shoe are exposed for receiving complementary projections 154, 156′ and indentation 155′ of a further shoe of a further group of shoes.

Further, when assembled into a unit 90 of three shoes, the projections 142 and 144 along the side margin 137 of the second shoe mesh into the indentations 106 and 108, and along the side margin 104 of the first shoe, and the projection 110 along the side margin 104 of the first shoe meshes into the indentation 140 along the side margin 137 of the second shoe. The throughbore 116 of the projection 110 of the first shoe and the throughbores 146, 148 of the projections 142, 144 of the second shoe are in straight line axial alignment with one another to receive therethrough the hinge pin 120. In this assembly, the projections 154 and 156 and the indentation 155 disposed along the side margin 150 of the second shoe are exposed to mesh within respective ones of the projection 212′ and indentations 218′ and 220′ of a further third shoe, as seen in FIG. 13. Thus, multiple units 91 of three shoes each are provided in interconnected relationship to define the flange 12.

As depicted in FIGS. 1, 8 and 13, the central first shoe of each unit of shoes is provided with a lug 157 projecting from the body portion thereof. This lug includes a throughbore 159 for the receipt therein of a hinge pin 159 to hingedly connect the lug to its respective actuator 52. In the depicted embodiment, each unit of shoes is connected to a respective actuator. Accordingly, upon actuation of the actuator, a force is applied to each central first shoe to move this first shoe either radially inwardly or outwardly relative to the rotational axis 56. As will be recognized by one skilled in the art, each of the actuators may be connected to a single source of energy (such as a source of hydraulic pressure)such that all actuators function simultaneously, to apply the same degree of force, in the same direction, to move all of the actuators, hence all of the shoes either radially outwardly or inwardly at the same time, by the same amount.

Upon the application of a moving force to the first shoe of each unit of shoes in a radial direction, this shoe swings about its hinged attachment location 65 to the flange ring, and the outboard end of this first shoe responds by moving in such radial direction. By reason of the hinged relationship of the second and third shoes to the first shoe, the radial movement of the first shoe carries the second and third shoes with it while at the same time increasing or decreasing the spatial relationship between the second and third shoes relative to the first shoe (depending upon the direction of the force), causing the second and third shoes to move about their hinged connections to the first shoe and, in the case of a radially inward force applied to the first shoe, tend to fold themselves toward the first shoe. That is, the plane of each of the second and third shoes tends to move toward parallolity with the plane of the first shoe. This folding function serves to permit the movement of the third shoes into contiguous relationship as depicted in FIG. 13, with their respective second and third shoes folded into juxtaposition thereto. When a radially outwardly directed force is applied to the third shoes, the aforedescribed relative movement of the second and third shoes is reversed. As depicted in FIGS. 3 and 13, the outward movement of the shoes results in the defining of the circumferential flange 12.

As depicted in FIGS. 3 and 13-14, when assembled, each unit of shoes is hinged together along respective ones of flanking units of shoes. In the depicted group of FIG. 4, the apex 101 of the central shoe is disposed most radially outwardly relative to the flange when the flange is radially extended. As noted, the orientation of the units of shoes of FIG. 3 depicts the outer circumferential surface 90 collectively defined by the depicted units of shoes when the respective flange is in its fully extended attitude and facing outwardly of the plane of the drawing.

Referring specifically to FIGS. 3 and 13-14, multiple units of shoes are hingedly interconnected to define a circumferential flange. In the depicted embodiment of FIG. 3, the shoes 92, 94 and 96 comprise a first unit 91 of shoes. The shoes 92′, 94′ and 86′ comprise a second group of shoes. This pattern of units of three shoes is repeated to define the circumferential flange 12. Notably only the first shoe of each unit of shoes is hinged to the rim of the flange ring 64. In the embodiment of FIG. 1 and the embodiment of the central first shoe of FIG. 5, the body portion of each central first shoe is joined to the outboard end 155 of a link 157 and the link extends from the first shoe to be operatively connected to the actuator 52. This connection of the link to the actuator may include one or more further links as desired to effect rotational movement of the first shoe about its hinged junction to the rim of the flange ring. Alternatively, the end of the link may be joined to the junction between the third shoe of a first unit of shoes and the second shoe of an adjacent and second group of shoes. Once all of the groups of shoes defining the flange are hingedly interconnected, the individual shoes of the flange may be simultaneously rotated from respective positions radially inwardly (partially or fully as desired) of the drum and respective positions radially outwardly of the drum.

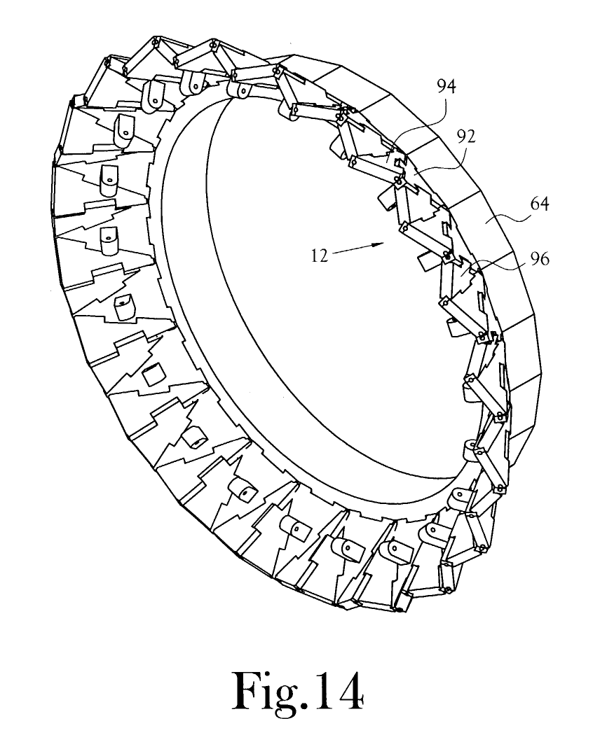

FIG. 14 schematically depicts a flange of the present invention with its shoes in their partially extended positions. FIG. 3 schematically depicts the flange with its shoes in their fully retracted (inward of drum) positions.

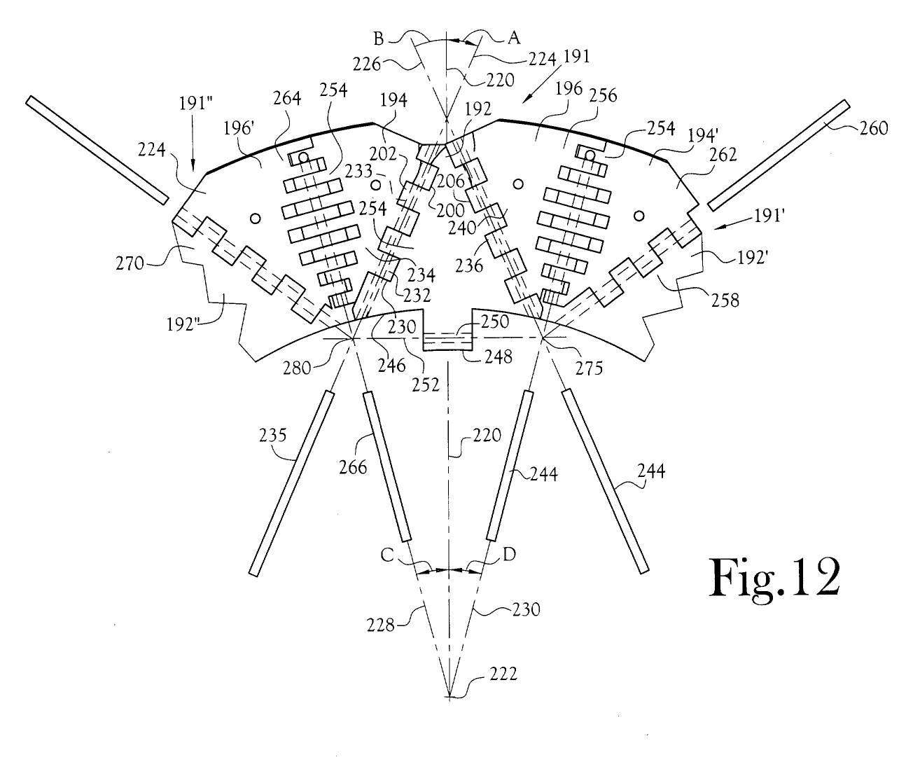

In FIG. 12 there is depicted an alternative embodiment of a unit 191 of three shoes comprising a central first shoe 192, a second shoe 194 and a third shoe 196. In this embodiment, each of the shoes, in plan view, is of a substantially triangular geometry. The first shoe includes a first plurality of alternating indentations 200 (typical) and projections 202 (typical) disposed along a first side margin 204 of this shoe and a second plurality of alternating indentations 206 (typical) and projections 208 (typical) disposed along a second side margin 210 of this shoe. The second shoe 194 of this unit 191 is similarly provided with a first plurality of indentations 230 (typical) and projections 232 (typical) disposed along a first side margin 234 of this shoe. These indentations and projections mesh with the indentations and projections disposed along the first side margin 204 of the first shoe. Each of the projections of the first side margin 234 of the second shoe and of the first side margin 204 of the first shoe are provided with throughbores 233 (typical) which are in straight line axial alignment to receive therethrough a hinge pin 235, thereby developing a hinged relationship between the first and second shoes.

The third shoe 196 of the unit 191 similarly includes a first plurality of alternating indentations 236 (typical)and projections 238 (typical) disposed along a first side margin 240 thereof. These indentations and projections of the third shoe mesh with the indentations and projections of the second side margin of the first shoe. Each of the projections associated with the first side margin of the third shoe and with the second side margin of the first shoe are provided with throughbores 242 (typical) which are in straight line axial alignment to receive therethrough a hinge pin 244, thereby developing a hinged relationship between the first and third shoes. It is noted that the hinged relationship of the second shoe with the first shoe is independent of the hinged relationship of the third shoe with the first shoe.

In the embodiment depicted in FIG. 12, the base 246 of the first shoe 192 is provided with a mounting lug 248′ adapted to hingedly mount the third shoe to a flange ring, defining a hinge axis 252. To this end, a throughbore 250 is provided through the mounting lug 248 to receive therethrough a hinge pin 252 adapted to mount the first shoe to the flange ring as at location 65 depicted in FIG. 1.

Further in the embodiment of FIG. 12, there is depicted a second shoe 194′ of a further unit 191′ of shoes, the indentations and projections disposed along a side margin 254 thereof meshing with the indentations and projections disposed along the second side margin 256 of the third shoe of the first unit 191 of shoes, and a portion of a first shoe 192′ of the further unit 191′ of shoes whose indentations and projections along its side margin 258 mesh with, and are hingedly joined by a hinge pin 260, to the indentations and projections disposed along the side margin 262 of the second shoe 194′ of the further unit of shoes.

In similar manner, in FIG. 12 there is depicted a portion of a still further unit 191″ of shoes wherein the indentations and projections disposed along a side margin 264 of a still further third shoe 196′ mesh with, and are hinged to, as by a hinge pin 266, the indentations and projections disposed along the side margin 254 of the second shoe 194 of the first unit 191 of shoes. A portion of a still further first shoe 192″ of the still further unit 191″ of shoes is depicted with the indentations and projections disposed along a side margin 270 thereof meshing with and hinged, as by a hinge pin 272, to the indentations and projections disposed along a side margin 274 of the still further third shoe 196′.

In the embodiment of FIG. 12, it is noted that the axes 224, 226 of the hinge pins 235 and 244, respectively, intersect at a common point 275. In like manner, the axes 276, 278 of the hinge pins 244 and 266, respectively, intersect at a common point 280. In each instance, the common point lies on the axis 252 of the hinge pin which is employed to hingedly mount the third shoe 192 of a unit 191 of shoes to the flange ring. This orientation of the hinge axes of the shoes of each unit of shoes and the hinge axes between adjacent units of shoes has been found useful in ensuring maximization of the folding of the shoes relative to one another without interference between the individual shoes of each unit and the shoes of adjacent units of shoes.

Referring to FIG. 12 as an example, in a specific embodiment for the manufacture of a vehicle tire of 24.5 inches outer diameter, the angular relationships between the hinged side edges of the first 192, second 194 and third 196 shoes of a first unit 191 and further laterally disposed further units 191′ and 191″ of shoes, and a radius 220 of the drum originating at the rotational axis 272 of the drum, are depicted. In this example, the extended axis 224 of the hinged side edges between the first 192 and second 194 shoes and the extended axis 226 between the hinged side edges between the first 191 and third 196 shoes each define angles A and B, respectively, with respect to a radius 220 of the drum, of 23.538 degrees. In this same example, the extended axis 228 of the hinged side edges between the second 194 shoe of the first unit 191 of shoes and a third shoe 196′ of a further unit 191′″ of shoes, and the extended axis 230 of the hinged side edges between the third shoe 196 of the first unit 191 of shoes and a further second shoe 194′ of a further unit 191′ of shoes, each define angles C and D, respectively, relative to a radius 220 of the drum, of 15.000 degrees. It will be recognized that other, but like, angles of these axes relative to a radius of the drum may be employed when employing a drum of a different diameter for a tire of a different diameter.

Whereas specific examples and embodiments have been described herein, it will be recognized that other suitable embodiments of the various elements of the present invention may be employed. Specifically, it is to be recognized by one skilled in the art that the depicted embodiments of the shoes of the present invention, as well as their relative positions when in their full or partial extended and/or retracted positions relative to the rotational axis of the drum are schematic in various of the Figures, and that for a specific size or design of a tire desired to be manufactured, the concepts disclosed herein may be readily applied, with recognized adaptations as required in an given instance

Having thus described the aforementioned invention, we claim:

1. A flange for a tire building drum having a transverse central plane and including a central shaft having a longitudinal axis which defines a rotational axis of the drum comprising first and second sets of outer-circumference defining shoes which are expandable from radially retracted positions internally of the drum to radially extended positions to define first and second mirror image circumferential radial flanges which are disposed on respective ones of the opposite sides of, and parallel to, the transverse central plane of the drum, each set of shoes including a plurality of individual shoes, each of which is a generally triangular geometry when viewed in a plan view thereof and having respective apices, bases and opposite sides.

2. The flange of claim 1 wherein each set of shoes defining a flange comprises multiple units of at least three shoes per unit.

3. The flange of claim 1 wherein at least one shoe of each of said units of shoes is mounted on said flange ring for movement of said shoes of said units of shoes between radially extended and radially retracted positions relative to the rotational axis of the drum.

4. The flange of claim 2 wherein said shoes of each unit of three shoes includes a central first shoe and second and third shoes disposed in flanking relationship to said first shoe, said central first shoe being of generally isosceles triangular geometry.

5. The flange of claim 4 wherein each shoe of each unit of shoes is of generally triangular geometry.

6. The flange of claim 4 wherein each unit of shoes comprises a central first shoe and second and third shoes, each of said shoes including a base and opposite sides, each of said opposite sides of each of said shoes including alternating projections and indentations therealong, said projections of one side of each of said second and third shoes being hingedly received with corresponding indentations along a respective one of said opposite sides of said central first shoe when said shoes of a unit of shoes are assembled in side-by-side relationship and with the base of each of said second and third shoes disposed opposite the base of said central first shoe.

7. The flange of claim 6 wherein said plurality of units of shoes are hingedly interconnected together along respective ones of their sides which are outboard of their side which is interconnected to said central first shoe, to collectively define a circumferential outer surface of the flange.

8. The flange of claim 7 and including throughbores through each of said projections of each shoe, said throughbores through said projections of each shoe being in straight line registration with one another, said throughbores of those projections of each shoe which intermesh with throughbores of an adjacent shoe being in register, and including hinge pin means disposed within said registered projections.

9. The flange of claim 6 and including a flange ring disposed in encircling relationship to the shaft and at least one actuator associated with said flange ring, each of said central first shoes of each unit of shoes including a lug projecting outwardly therefrom and adapted to hingedly engage said flange ring along a hinge line which is substantially perpendicular to a radius of said drum.

10. The flange of claim 9 wherein said lug includes a first end which is attached either generally centrally of said central first shoe or to a location adjacent the juncture of the apex of said triangular central first shoe and the base of one of said first and second shoes of the unit of shoes which contains said central first shoe. 21
